(19) United States
(12) Patent Application Publication
(10) Pub. No.: US 2011/0060741 A1
(43) Pub. Date: Mar. 10, 2011

(54) DISTRIBUTION AND USAGE OF MEDIA BUNDLES

(76) Inventors: David Heller, Los Altos, CA (US); Jeffrey L. Robbin, Los Altos, CA (US); Max Muller, San Jose, CA (US); Aaron Braunstein, San Jose, CA (US)

(21) Appl. No.: 12/555,643

(22) Filed: Sep. 8, 2009

(51) Int. Cl. G06F 15/16; G06F 17/30

(52) U.S. Cl. 707/741; 709/217; 707/E17.002

(57) ABSTRACT

Media bundles described herein can associate digital media assets so as to be able to provide media presentations involving the digital media assets at a client device. A media bundle can be used on a client device to support media presentation of digital media assets at the client device. The media presentation can provide a multimedia experience for the user of the client device. Conversion data can be provided to the client device to facilitate mapping from provider identifiers within the media bundle to identifiers used by a media distribution system.

### CROSS-REFERENCE TO OTHER APPLICATIONS

This application references: (i) U.S. patent application Ser. No. ______ [Att. Dkt. No. 101-P693], filed concurrently herewith, and entitled “PROGRAMMING INTERFACE FOR USE BY MEDIA BUNDLES TO PROVIDE MEDIA PRESENTATIONS”, which is herein incorporated by reference; and (ii) U.S. patent application Ser. No. ______ [Att. Dkt. No. 101-P699], filed concurrently herewith, and entitled “DIGITAL MEDIA BUNDLES FOR MEDIA PRESENTATION PLAYBACK”, which is herein incorporated by reference.

### BACKGROUND OF THE INVENTION

1. Field of the Invention

The present invention relates to media bundles including, but limited to, accessing media content identified by media bundles.

2. Description of the Related Art

Content providers have been able to submit digital media assets under their control to an online media distribution site for further distribution. In recent years, advanced online media distribution sites, such as the iTunes™ Store provided by Apple Inc. of Cupertino, Calif., have permitted online submission of digital media assets, such as songs, movies, television shows and application programs, to the online media distribution sites. Although content providers have conventionally identified their digital media assets using their own identification scheme, conventionally advanced online media distribution sites would, upon submission, assign their own internal unique identifiers for the digital media assets. The unique identifiers would then be thereafter used to uniquely identify particular digital media assets at the online media distribution site as well as in local user libraries after the assets have been acquired. These differing identification schemes can make it difficult or impossible for content providers to access or retrieve digital media assets from local media libraries where the digital media assets have been acquired from online media distribution sites.

Thus, there is a need for a system that permits content providers to continue to utilize their own identification schemes, while also allowing online media distribution sites to use their identification schemes.

### SUMMARY

Media bundles described herein can associate digital media assets so as to be able to provide media presentations involving the digital media assets at a client device. A media bundle can be used on a client device to support media presentation of digital media assets at the client device. The media presentation can provide a multimedia experience for the user of the client device.

In one embodiment, digital media assets associated with a media bundle can be identified on submission of the media bundle to a network-based media distribution system even if the digital media assets are not yet available for distribution. When the submitted media bundle is subsequently distributed to a user's client device, the digital media assets that are referenced by the media bundle via provider identifiers can, as needed, be identified at the client device using conversion data that can map from provider identifiers to distributor identifiers. The conversion can optionally also support associating more than one distributor identifier to a given provider identifier so as to associate the given product identifier to one or more alternative or equivalent digital media assets.

The client device can, for example, be a computing device. Examples of a computing device include a personal computer (e.g., desktop computer, notebook computer, netbook computer, etc.), or a portable handheld electronic device (e.g., Portable Digital Assistant (PDA), portable media player, multi-function mobile telephone, etc.).

The invention can be implemented in numerous ways, including as a method, system, device, apparatus (including computer readable medium and graphical user interface). Several embodiments of the invention are discussed below.

In one embodiment, a computer-implemented method for presenting one or more digital media assets at a client machine, can, for example, initiate a media presentation program on the client machine, where the media presentation program requests playback of at least one identified digital media asset. A determination can be made of whether the identified digital media asset whose playback is requested is available from a local media library associated with the client device. The identified digital media asset is retrieved from the local media library if the identified digital media asset is determined to be available from the local media library associated with the client device. A determination of an equivalent digital media asset that is deemed equivalent to the identified digital media asset can be made if the identified digital media asset is determined not to be available from the local media library associated with the client device. It can then be determined whether the equivalent digital media asset is available from the local media library associated with the client device. The equivalent digital media asset can be retrieved from the local media library if the equivalent digital media asset is determined to be available from the local media library associated with the client device. Thereafter, the retrieved identified digital media asset or the retrieved equivalent digital media asset can be played.

In another embodiment, a computer-implemented method for providing conversion data on a client device for facilitating identification of digital media assets to be utilized on the client device can, for example, receive a media bundle having a plurality of bundle components. The bundle components can be stored in local storage in the client device. Conversion data for provider identifiers can be requested from a distribution server. Once the conversion data is received, the conversion data can be stored in the local storage at the client device.

In another embodiment, as a computer-implemented method for providing conversion data to a client device for facilitating identification of digital media assets to be utilized on the client device, can, for example, electronically send a media bundle having a plurality of bundle components from a distribution server to the client device. The media bundle can include at least provider identifiers for a plurality of digital media assets and a media presentation program that on operation uses the digital media assets. A request for conversion data pertaining to the provider identifiers can then be displayed. The conversion data pertaining to the provider identifiers can be electronically sent to the client device.

In one embodiment, a computer readable medium including at least computer program code tangibly stored thereon for providing conversion data to a client device for facilitating identification of digital media assets to be utilized on the client device can, for example, include at least computer program code for providing a media bundle having a plurality of bundle components at a distribution server; and computer program code for electronically sending the media bundle from the distribution server to the client device. The media bundle being sent to the client device can include at least provider identifiers for a plurality of digital media assets, a media presentation program that on operation uses the digital media assets, and conversion data pertaining to the provider identifiers.

In another embodiment, a computer readable medium including at least computer program code tangibly stored thereon for providing conversion data to a client device for facilitating identification of digital media assets to be utilized on the client device can, for example, include at least computer program code for electronically sending a media bundle having a plurality of bundle components from a distribution server to the client device, The media bundle can include at least provider identifiers for a plurality of digital media assets and a media presentation program that on operation uses the digital media assets. The computer readable medium can also include computer program code for determining conversion data pertaining to the provider identifiers, and computer program code for electronically sending the conversion data pertaining to the provider identifiers to the client device.

In another embodiment, a computer readable medium including at least computer program code tangibly stored thereon for providing conversion data on a client device for facilitating identification of media items to be utilized on the client device can, for example, include at least computer program code for receiving a media bundle having a plurality of bundle components. The computer readable medium can also include computer program code for storing the bundle components in local storage in the client device, computer program code for receiving conversion data at the client device from a distribution server, and computer program code for storing the conversion data in the local storage at the client device.

In another embodiment, a computer readable medium including at least computer program code tangibly stored thereon for presenting one or more digital media assets at a client machine, can, for example, include at least computer program code for initiating a media presentation program on the client machine. The media presentation program can request playback of at least one identified digital media asset identifier by a provider identifier. The computer readable medium can also include computer program code can be provided to convert the provider identifier to a distributor identifier used to identify the identified digital media asset acquired from an online media distribution server and stored in a local media library associated with the client device. The computer readable medium can also include computer program code can also determine whether the identified digital media asset whose playback is requested is available from the local media library associated with the client device based on a distributor identifier. The computer readable medium can also include computer program code can also retrieve the identified digital media asset from the local media library if the identified digital media asset is determined to be available from the local media library associated with the client device. Finally, the computer readable medium can also include and computer program code for playing the retrieved identified digital media asset.

In still another embodiment, a computer readable medium can include at least computer program code tangibly stored thereon for presenting one or more digital media assets at a client machine, can, for example, include at least computer program code for initiating a media presentation program on the client machine. The media presentation program can request playback of at least one identified digital media asset. The computer readable medium can also include computer program code for determining whether the identified digital media asset whose playback is requested is available from a media library associated with the client device. The computer readable medium can also include computer program code for retrieving the identified digital media asset from the media library if the identified digital media asset is determined to be available from the media library associated with the client device. In addition, the computer readable medium can also include computer program code for determining an equivalent digital media asset that is deemed equivalent to the identified digital media asset if the identified digital media asset is determined not to be available from the media library associated with the client device, computer program code for determining whether the equivalent digital media asset is available from the media library associated with the client device, and computer program code for retrieving the equivalent digital media asset from the media library if the equivalent digital media asset is determined to be available from the media library associated with the client device. Further, the computer readable medium can include computer program code for playing the retrieved identified digital media asset or the retrieved equivalent digital media asset.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like elements, and in which:

FIG. 1 is a block diagram of a product submission and distribution system according to one embodiment.

FIG. 2 is a block diagram of a media presentation system according to one embodiment.

FIG. 3 is a flow diagram of a conversion data acquisition process according to one embodiment.

FIG. 4A is a flow diagram of a bundle content delivery process according to one embodiment.

FIG. 4B is a flow diagram of a bundle distribution process according to one embodiment.

FIGS. 5A and 5B are flow diagrams of a media presentation process according to one embodiment.

FIG. 6 is a block diagram of an exemplary computing device suitable for use with the invention.

### DETAILED DESCRIPTION OF EMBODIMENTS OF THE INVENTION

Media bundles described herein can associate digital media assets so as to be able to provide media presentations involving the digital media assets at a client device. A media bundle can be used on a client device to support media presentation of digital media assets at the client device. The media presentation can provide a multimedia experience for the user of the client device.

In one embodiment, digital media assets associated with a media bundle can be identified on submission of the media bundle to a network-based media distribution system even if the digital media assets are not yet available for distribution. When the submitted media bundle is subsequently distributed to a user's client device, the digital media assets that are referenced by the media bundle via provider identifiers can, as needed, be identified at the client device using conversion data that can map from provider identifiers to distributor identifiers. The conversion can optionally also support associating more than one distributor identifier to a given provider identifier so as to associate the given product identifier to one or more alternative or equivalent digital media assets.

The client device can, for example, be a computing device. Examples of a computing device include a personal computer (e.g., desktop computer, notebook computer or netbook computer), or a portable handheld electronic device (e.g., Portable Digital Assistant (PDA), multi-function mobile telephone).

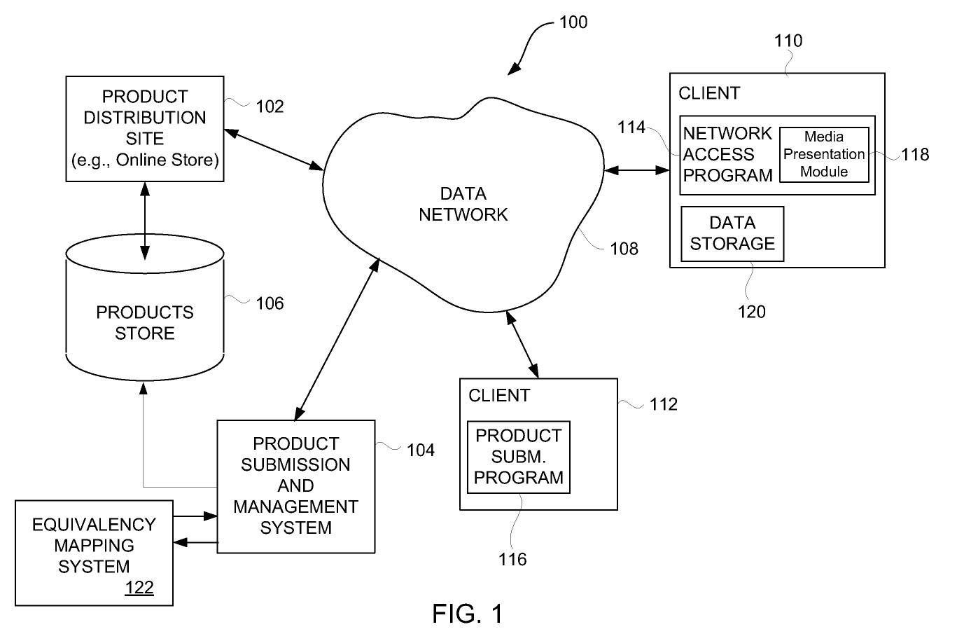

Several embodiments of the invention are discussed below with reference to FIGS. 1-6. However, those skilled in the art will readily appreciate that the detailed description given herein with respect to these figures is for explanatory purposes as the invention can extend beyond these limited embodiments.

FIG. 1 is a block diagram of a product submission and distribution system 100 according to one embodiment. The product submission and distribution system 100 can include a product distribution site 102. The product distribution site 102 can provide an online access point for distribution of various digital products. For example, the product distribution site 102 can be referred to as an online store. A product submission and management system 104 can operate to receive submissions of digital products from various digital product submitters. The product submission and management system 104 can process submission of digital products and authorize distribution of approved digital products. The digital products can be stored in a products store 106. In one embodiment, the products store 106 includes a mass data store and one or more databases. The products store 106 can provide mass storage of the numerous digital products that are available for distribution (e.g., purchase or rental). For example, digital products that have been purchased can be accessed from the products store 106 over a data network 108 by way of the product distribution site 102. Examples of digital products include media items or computer program products. Media items can pertain to music (e.g., songs or albums) or video (e.g., movies or television shows). Computer program products can pertain to applications (or application programs), animations, or presentations.

The product submission and distribution system 100 can also include a first client 110 and a second client 112. Typically, the product submission and distribution system 100 can also include a plurality of different clients 110, 112. The first client 110 can include a network access program 114. The second client 112 can include a product submission program 116. Some clients can also include both the network access program 114 and the product submission program 116.

The network access program 114 can be an application program (e.g., software application) that operates on the first client 110, which is a computing device. One example of a suitable network access program is a network browser (e.g., Microsoft Explorer or Safari). Another example of a suitable network access program is iTunes™ offered by Apple Inc. The first client 110 can be coupled to the product distribution site 102 through the data network 108. Hence, the first client 110 can interact with the product distribution site 102 to review, purchase, execute, play and/or manage digital products.

The network access program 114 can include a media presentation module 118. The media presentation module 118 can operate to provide a media presentation at the first client 110. The first client 110 can have a media bundle that governs the media presentation. A media bundle can be considered a digital product. A media bundle can also be considered part of or a supplement to another digital product, such as a digital media asset. A media bundle includes bundle components which can include digital media assets as well as computer program code. The computer program code can serve to define and/or control the presentation. The presentation can, for example, present one or more digital media assets at the first client 110. The media presentation module 118 can execute or interpret the computer program code within the media bundle to provide the presentation at the first client 110. For example, in one embodiment, the computer program code within the media bundle is a script language, such as Javascript. The first client 110 can also provide a data storage 120 that provides local storage for various digital products. The stored digital products (e.g., digital media assets, media bundles, etc.) can be considered a media library (e.g., local media library).

The product submission program 116 can be an application program (e.g., software application) that operates on the second client 112, which is a computing device. The product submission program 116 can be used to submit digital products to the product submission and management system 104 for eventual distribution by the media distribution site 102. Although the network access program 114 and the product submission program 116 are shown in FIG. 1 as separate programs, it should be understood that such programs can be integrated into a single program or reside on the same client machine.

The media distribution system 100 can also include an equivalency mapping system 122. The equivalency mapping system 122 can interact with the product submission and management system 104 to identify digital media assets that are equivalent to one another. By using computer-implemented techniques to determine which digital media assets are equivalent to one another, digital media assets within media bundles can make use of “equivalent” digital media assets if the exact digital media asset specified by the media bundle is unavailable at the first client 110. The “equivalent” digital media assets are backup or alternative digital media assets that can be used in place of a specified digital media asset that is not available.

In the product submission and distribution system 100 shown in FIG. 1, the digital products can be submitted to the product submission and management system 104 by way of the product submission program 116. The digital products that have been submitted (e.g., via the second client 112) can be processed and then stored in the products store 106. Thereafter, the stored digital products can be available to be purchased from the product distribution site 102. Upon purchasing a particular digital product, the product distribution site 102 can permit the digital data for the particular digital product to be retrieved from the products store 106 and then delivered (e.g., downloaded) from the product distribution site 102 to the requesting client 110 through the data network 108. In this regard, the product distribution site 102 or some other delivery server (not shown) can obtain the digital data corresponding to the particular digital product from the products store 106 and downloads such digital data through the data network 108 to the client 110. The downloaded digital data can then be stored on the client 110. In one embodiment, the downloaded digital data is encrypted as received at the client 110 but is decrypted and then perhaps re-encrypted before persistently stored on the client 110. Thereafter, the client 110 can utilize (e.g., execute) the digital data of the digital product at the client 110.

The product submission and distribution system 100 may allows a user of the client 110 to utilize the network access program 114 to browse, search or sort through a plurality of digital products that can be purchased from the product distribution site 102. The network access program 114 may also allow the user to preview or demo some or all of a digital product. In the event that the user of the network access program 114 desires to purchase a particular digital product, the user (via the network access program 114) and the product distribution site 102 can engage in an online commerce transaction in which the user pays for access rights to the particular digital product.

The submission and purchase of the digital products can be achieved over the data network 108. In other words, the submission and purchase of the digital products can be achieved online. The purchase of media items online can also be referred to as electronic commerce (e-commerce). In one embodiment, the data network 108 includes at least a portion of the Internet. The clients 110, 112 can vary with application but generally are computing devices that have memory storage. Often, the clients 110, 112 are personal computers or other computing devices that are capable of storing and presenting media to their users. In one embodiment, the connections through the data network 108 between the product distribution site 102 and the clients 110, 112 can be through secure connections, such as Secure Sockets Layer (SSL).

Although the product distribution site 102, the product submission and management system 104, the products store 106 and the equivalency mapping system 122 are shown in FIG. 1 as being separate components, it should be understood that any of these components can be combined into one or more apparatus. For example, the product submission and management system 104 can be incorporated into the product distribution site 102. As another example, the products store 106 can be incorporated into the product distribution site 102 or the product submission and management system 104.

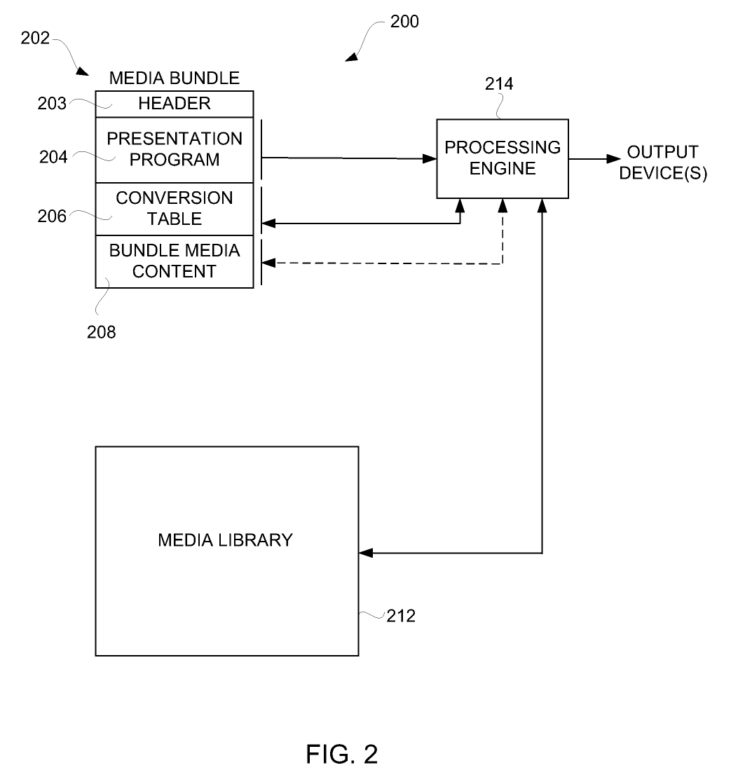

FIG. 2 is a block diagram of a media presentation system 200 according to one embodiment. The media presentation system 200 includes a media bundle 202. The media bundle 202 is a container for a plurality of bundle components. In the embodiment of the media bundle 202 illustrated in FIG. 2, the bundle components for the media bundle 202 include: a header 203, a presentation program 204, a conversion table 206, and bundle media content 208. The media presentation system 200 also includes a media library 212 that stores various digital media assets. In particular, in one embodiment, the media bundle 202 is associated with at least one particular digital asset stored in the media library 212. As one example, the media bundle 202 can be associated with at least one digital media asset corresponding to a movie, an album of songs, or a television show. The header 203, for example, can include data that associates the media bundle 202 to the at least one particular digital media asset.

The media presentation system 200 also includes a processing engine 214. The processing engine 214 can, in one embodiment, operate to perform the presentation program 204 with respect to the media bundle 202 so as to produce output data for one or more output devices. The output devices are, for example, a display and/or speaker. The processing engine 214 can execute or interpret the presentation program 204 of the media bundle 202. In executing or interpreting the presentation program 204, the processing engine 214 will be directed to access and present one or more of the digital media assets. These digital media assets can be in the bundle media content 208 and/or in the media library 212. Since the digital media assets in the media library 212 may come from a media distribution system before, with or after receiving the media bundle 202, these digital media assets in the media library 212 are primarily identified using distributor identifiers.

In some cases, these digital media assets may be identified in the presentation program 204 by the use of a producer identifier. The processing engine 214 can utilize and interact with the conversion table 206 provided in the media bundle 202 to convert the provider identifiers to distributor identifiers that are understood by the media distribution system. Since the media distribution system provides the digital media assets associated with the media bundle 202 to the media library 212, the processing engine 214 needs to associate provider identifiers to the distributor identifiers so that the appropriate digital media assets may be located and utilized by the presentation program 204 to produce the desired output for the one or more output devices.

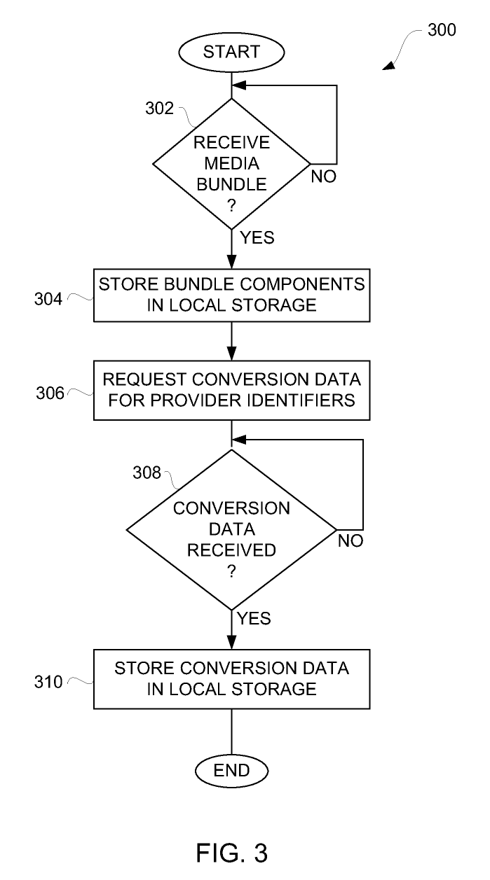

FIG. 3 is a flow diagram of a conversion data acquisition process 300 according to one embodiment. The conversion data acquisition process 300 can be performed by a client device, such as the client device 110 illustrated in FIG. 1.

The conversion data acquisition process 300 can begin with a decision 302 that determines whether a media bundle has been received. A media bundle can be received at a client device through purchase of the media bundle from a media distribution server or through other acquisition of the media bundle. For example, the media distribution server can host an online media store that makes digital media assets, including media bundles, available for acquisition. In one embodiment, the media bundles are acquired as part of another digital media asset, such as a movie, album or TV series. The client device can receive the media bundle from the media distribution server or other means. When the decision 302 determines that a media bundle has not been received, the conversion data acquisition process 300 can await a receipt of a media bundle.

On the other hand, once the decision 302 determines that a media bundle has been received, bundle components associated with the media bundle can be stored 304 in a local storage. The local storage can be data storage associated with the client device. The bundle components within the media bundle can, for example, include a presentation program, bundle media content, and a conversion table. Certain of the bundle components (e.g., bundle media content) can also include provider identifiers that are presumably unique identifiers provided by content providers and associated with particular digital media assets.

The media distribution server utilizes distribution identifiers to uniquely identify digital media assets at or distributed by the distribution server. Hence, digital media assets provided in a digital media library (e.g., media library 212) at the client device may include digital media assets that are identified by distributor identifiers but not provider identifiers. As result, there is a need to be able to convert provider identifiers into appropriate distribution identifiers. Although the media bundle (as supplied to the media distribution server) includes a conversion table, on submission that conversion table does not include the mappings. The media distribution server updates the conversion table with conversion data and thus providing the mappings. The conversion data provides data (or mappings) from provider identifiers utilized within the media bundle to distributor identifiers.

The conversion data for the conversion table can be inserted into the conversion table of the media bundle before the media distribution server delivers the media bundle to a client device. Alternatively, as shown in FIG. 3, the conversion data acquisition process 300 can request 306 conversion data from the media distribution server for the provider identifiers utilized within the media bundle. A decision 308 can then determine whether the requested conversion data has been received from the distribution server. When the decision 308 determines that the requested conversion data has not yet been received, the conversion data acquisition process 300 can await the receipt of the conversion data. Alternatively, when the decision 308 determines that the conversion data has been received, the conversion data can be stored 310 to the local storage associated with the client device. In any case, the conversion data can be stored in the conversion table of the media bundle that is stored to the local storage associated with the client device. Following the block 310, the conversion data acquisition process 300 can end.

Table I provided below pertains to an exemplary conversion table containing provider identifiers upon submission of a media bundle. The conversion table contains a list of provider identifiers that pertains to digital media assets referenced by the media bundle. However, at this time, the conversion table does not contain corresponding distributor identifiers.

TABLE I

| Provider Identifier | Distributor Identifier |
|---|---|
| provider123.new_song_abc | |
| provider123.new_video_def | |
| provider123.new_TVshow_ghi | |
| provider123.new_song_jkl | |

Table II provided below pertains to an exemplary conversion table that contains distributor identifiers that correspond to (e.g., map to) provider identifiers. Following submission of a media bundle, a media distribution server can complete the conversion table by adding conversion data thereto. The conversion table can be referred to as a mapping table, and the conversion data can also be referred to as mapping data. The conversion table shown in Table II represents the conversion table that is received at the client device from the media distribution server, either separate from or together with the media bundle.

TABLE II

| Provider Identifier | Distributor Identifier |
|---|---|
| provider123.new_song_abc | 01jgar12942; 01wkdh2k43; 01ifh371h3 |
| provider123.new_video_def | 02ics1482e |
| provider123.new_TVshow_ghi | 03ifo2kew4 |
| provider123.new_song_jkl | 01lsea19n4 |

As shown in Table II, in one embodiment, a given provider identifier can be associated with one or more distributor identifier. In the case where there are more than one distributor identifiers mapped to a particular provider identifier, in one embodiment, the first listed distributor can represent the same digital media assets as that denoted by the corresponding product identifier, and any other listed distributor identifiers can represent digital media assets that can be deemed equivalent to the corresponding product identifier. For example, as shown in Table II, the product identifier “provider123.new_song_abc” which pertains to a particular song can correspond exactly to the distributor identifier “01jgar12942” and equivalently to “01wkdh2k43” or “01ifh371h3”. The equiv distributor identifiers can be listed in order of preference. As an example, the particular song might be a live version of a song, and the matching distributor identifier would denote that same live version of the particular song, with the equivalent distributor identifiers, if any, denoting different versions of the particular song, such as a studio version of the particular song, a remix of the particular song, a “clean” version of the particular song, etc. The advantage of providing equivalent distributor identifiers is that when operating a media bundle at a client device to provide a media presentation, the presentation of digital media assets in accordance with the media bundle can be successfully performed even if the user's client device lacks the exact digital media asset so long as an acceptable alternative (e.g., equivalent) digital media asset is available.

A media bundle, as noted above, can include various bundle components. One bundle component is bundle media content (or bundle content) that can be digital media assets provided with the submission of the media bundle but for use by or as part of the media bundle. A user of a client device can acquire a media bundle when an associated digital media asset is acquired (e.g., purchased) from a media distribution server. In such case, the media bundle can be used to provide a media presentation with respect to the associated digital media asset as well as any bundle media content. The associated digital media asset can, for example, pertain to a movie, an album or a television series. In one embodiment, the media bundle (without media bundle content), the media bundle content, and the digital media asset associated with the media bundle can each be separately electronically delivered to a client device where such data is stored.

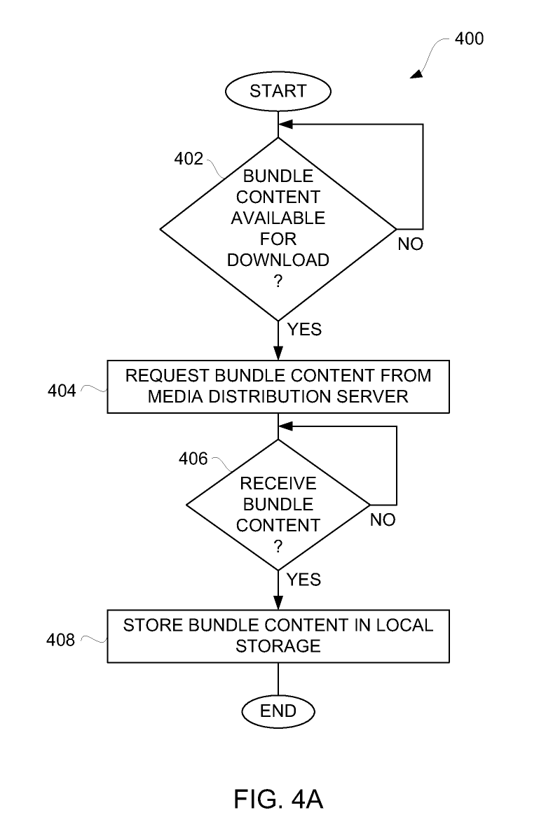

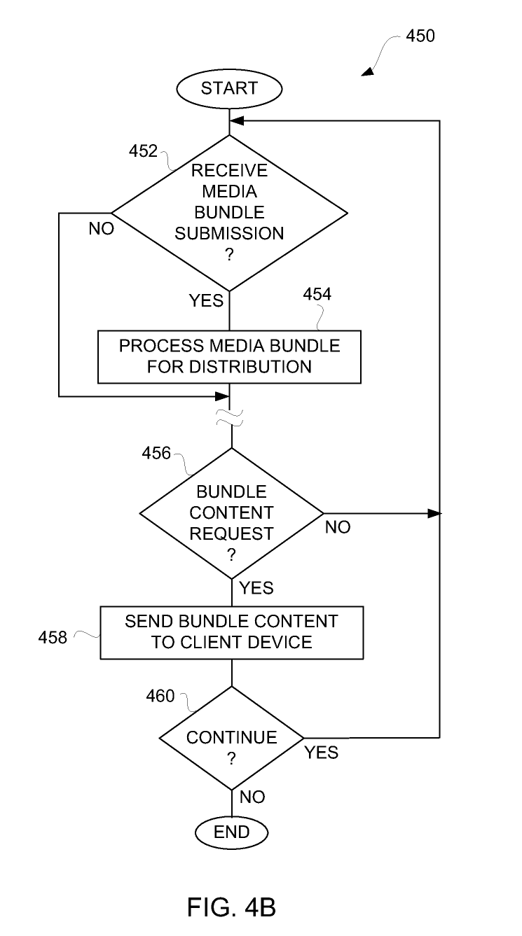

FIG. 4A is a flow diagram of a bundle content delivery process 400 according to one embodiment. The bundle content delivery process 400 can be performed by a client device, such as the client device 110 illustrated in FIG. 1.

The bundle content delivery process 400 can begin at a decision 402 that determines whether bundle content is available for download. After a user of a client device has acquired permission to receive a media bundle from the media distribution server, at least a framework for the media bundle is downloaded to and stored on the client device. However, typically, the media bundle also includes or references particular bundle content (media content for the media bundle) which is separate from the framework. As such, the bundle content of the media bundle may be subsequently delivered to the client device. Any subsequent delivery of the bundle content can, for example, be initiated at the client device automatically or on user's request. In any case, the bundle content delivery process 400 can begin with a decision 402 that determines whether bundle content is available for download to the client device. When the decision 402 determines that bundle content is not available for download to the client device, the bundle content delivery process 400 awaits a need to download available bundle content.

On the other hand, when the decision 402 determines that bundle content is available for download, the bundle content can be requested 404 from the media distribution server. The media distribution server can pertain to one or more servers partially or fully dedicated to downloading media content. As an example, the media distribution server can host the product distribution site 102 illustrated in FIG. 1.

Next, a decision 406 determines whether the bundle content has been received from the media distribution server. When the decision 406 determines that the bundle content has not yet been received, the bundle content delivery process 400 can await receipt of the bundle content. Once the decision 406 determines that the requested bundle content has been received, the bundle content can be stored 408 to the local storage at the client device. In one embodiment, the bundle content is stored 408 such that it is within or linked to the framework for the media bundle. Following the block 408, the bundle content delivery process 400 can end.

FIG. 4B is a flow diagram of a bundle distribution process 450 according to one embodiment. The bundle distribution process 450 can, for example, be performed by a media distribution server. For example, the bundle distribution process 450 can be performed by the product distribution site 102 illustrated in FIG. 1.

The bundle distribution process 450 can begin with a decision 452 that determines whether a media bundle submission has been received. The media bundle can include one or more bundle components as noted above. The submission of a media bundle can be performed by a content provider interested in having the media bundle be distributed by the media distribution server. When the decision 452 determines that a media bundle submission is received, the submitted media bundle can be processed 454 at the media distribution server. The processing 454 can vary depending on implementation but can include validation the media bundle. In one embodiment, the media bundle includes a conversion table as one of the bundle components, and conversion data can be processed 454 at the media distribution server to produce or update the conversion table. The processing 454 of the conversion data can produce mapping data for the conversion table. This conversion data can be inserted into a conversion table and/or can be maintained separately. When the decision 452 determines that a media bundle submission is not received, the block can be bypassed.

Following the block 454 or bypass thereof, various processing (not shown) can be performed by the media distribution server to support distribution of media bundles. For example, a user of a client device may browse, search or acquire a media bundle. However, at some point such processing can invoke a decision 456 that can determine whether a bundle content request is received. A bundle content request can be associated with delivery of a media bundle to the client device. The delivery of the media bundle to the client device can part of acquisition of the media bundle by a user operating the client device. When the decision 456 determines that a bundle content request is not received, the bundle distribution process 450 can return to repeat the block 452 and subsequent blocks. On the other hand, when the decision 456 determines that a bundle content request is received, the bundle content for the media bundle can be send 458 to the client device. Here, the one or more bundle components of the media bundle can be sent 458 to the client device. The one or more bundle components can be sent as one electronic package or can be sent as multiple separate electronic packages. The client device can request the one or more bundle components in a single request or over multiple requests.

Following the block 458, a decision 460 can then determine whether the bundle distribution process 450 should continue. When the decision 460 determines that the bundle distribution process 450 should continue, the bundle distribution process 450 can return to repeat the block 452 and subsequent blocks. Alternatively, when the decision 460 determines that the bundle distribution process 450 should continue, the bundle distribution process 450 can end.

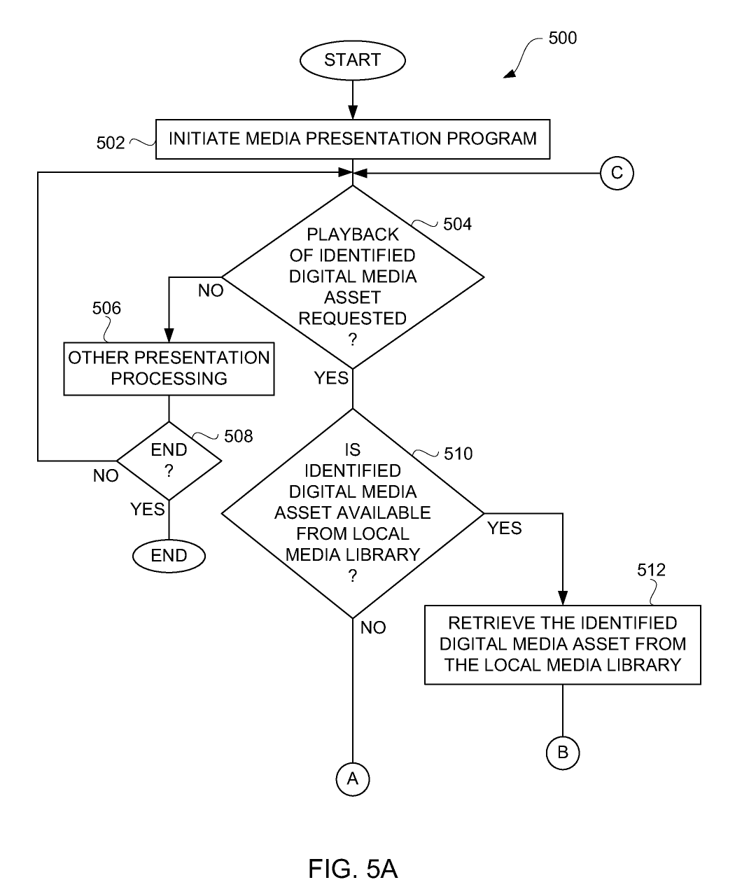

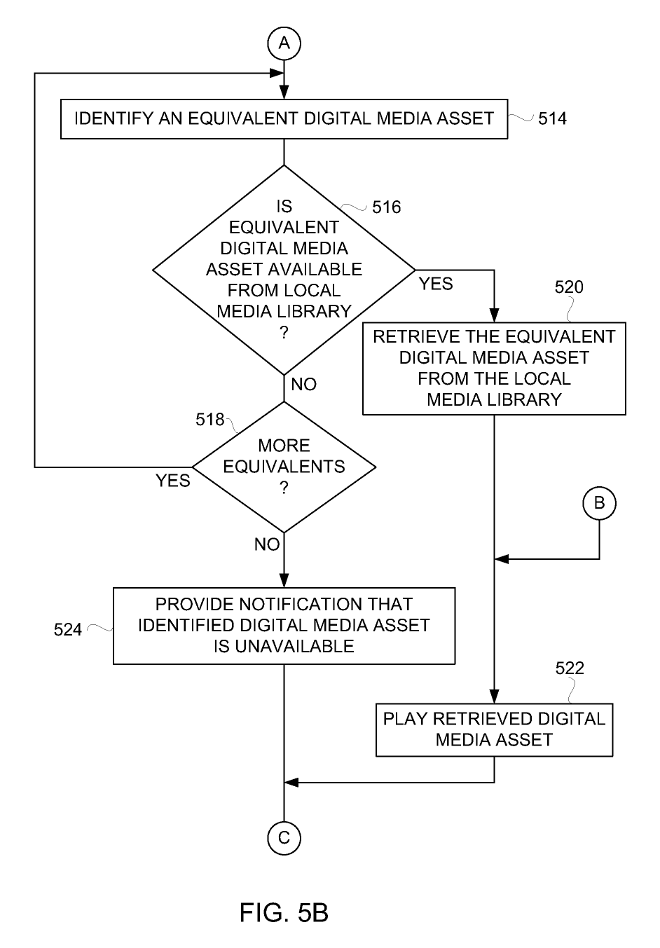

FIGS. 5A and 5B are flow diagrams of a media presentation process 500 according to one embodiment. The media presentation process 500 can pertain to processing performed by a client device, such as the client device 110 illustrated in FIG. 1.

The media presentation process 500 can initiate 502 a media presentation program. The media presentation program can be one bundle component of a media bundle. The media presentation program is a computer program that can control the presentation of media at the client device with respect to one or more bundle components within the media bundle.

Next, a decision 504 determines whether playback of an identified digital media asset has been requested. In executing or operating the media presentation program, there can be programming that seeks to access digital media assets. For example, programming code within the media presentation program can request that an identified digital media asset be played at the client device. Although the programming language can vary widely, in one implementation, the programming code is JavaScript.

When the decision 504 determines that playback of an identified digital media asset has not been requested, other presentation processing 506 can optionally be performed. For example, the other presentation processing 506 could cause text or images to be displayed on a display device associated with the client device. More generally, as an example, the other presentation processing 506 can cause one or more bundle media components to be presented at the client device. Following the optional block 506, a decision 508 can determine whether the media presentation process 500 should end. When the decision 508 determines that the media presentation process 500 should end, then the media presentation process 500 can end. Alternatively, when the decision 508 determines that the media presentation process 500 should not end, the media presentation process 500 returns to repeat the decision 504 and subsequent blocks so that the media presentation program can continue to effectively invoke media presentation processing.

On the other hand, when the decision 504 determines that playback of an identified digital media asset has been requested, the media presentation process 500 determines whether the identified digital media asset is available from a local media library at the client device. When the decision 510 determines that the identified digital media asset is available from the local media library, the identified digital media asset is retrieved 512 from the local media library. In alternative embodiments, the identified media assets might be retrieved from a media library not at the client device but nevertheless accessible to the client device (e.g., via a wireless network, a local area network, etc.).

Alternatively, when the decision 510 determines that the identified digital media asset is not available from the local media library, an equivalent digital media asset can be identified 514, if possible. Next, a decision 516 determines whether equivalent digital media asset is available from the local media library. When the decision 516 determines that an equivalent digital media asset is not available from the local media library, a decision 518 can determine whether there are more equivalents to be considered. When the decision 518 determines that there are more equivalent digital media assets to be considered, the media presentation process 500 can return to repeat the block 514 so that another equivalent digital media asset can be similarly processed.

On the other hand, when the decision 516 determines that the equivalent digital media asset is available from the local media library, the equivalent digital media asset can be retrieved 520 from the local media library. After the equivalent digital media asset has been retrieved 520, the retrieved digital media asset can be played 522. Also, following the block 512, the media presentation process 600 can proceed to the block 522 in the identified digital media asset was available from the local media library. Hence, in this situation, the identified digital media asset is available from the local media libraries so there is no need to determine and retrieve an equivalent digital media asset.

Alternatively, when the decision 518 determines that there are no more equivalent than digital media assets to be considered, a notification can be provided 524 that the identified digital media asset is unavailable. Following the blocks 522 and 524, the media presentation process 500 can return to repeat the decision 504 so that the media presentation program can continue to operate to provide presentation processing.

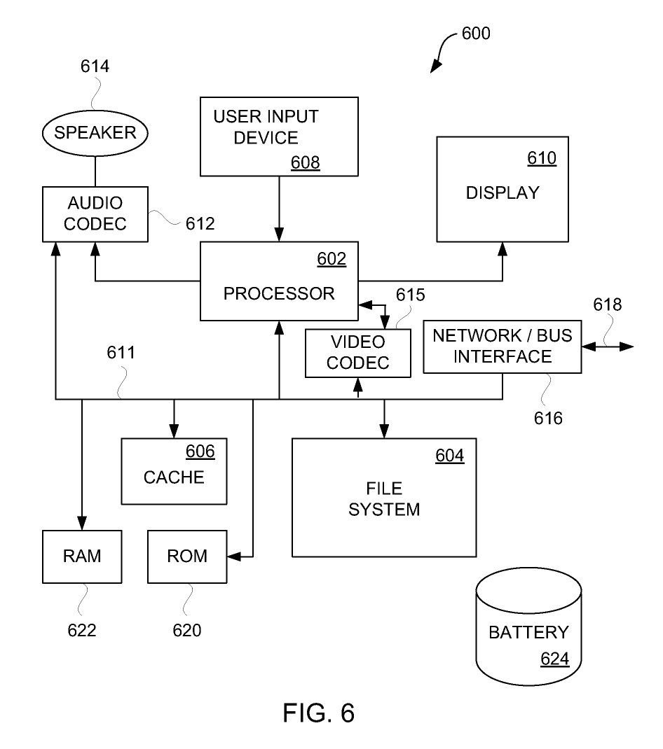

The computing device can, for example, be an electronic device. FIG. 6 is a block diagram of an exemplary computing device 600 suitable for use with the invention. The computing device 600 illustrates circuitry of a representative portable electronic device.

The computing device 600 includes a processor 602 that pertains to a microprocessor or controller for controlling the overall operation of the computing device 600. The computing device 600 stores data pertaining to electronic files in a file system 604 and a cache 606. The file system 604 is, typically, semiconductor memory (e.g., Flash memory) and/or one or more storage disks. The file system 604 typically provides high capacity storage capability for the computing device 600. However, since the access time to the file system 604 can be relatively slow, the computing device 600 can also include the cache 606. The cache 606 is, for example, Random-Access Memory (RAM) provided by semiconductor memory. The relative access time to the cache 606 is typically shorter than for the file system 604. However, the cache 606 does not have the large storage capacity of the file system 604. Further, the file system 604, when active, consumes more power than does the cache 606. The power consumption is often a concern when the computing device 600 is a portable computing device that is powered by a battery 624. The computing device 600 also includes a Read-Only Memory (ROM) 620 and a RAM 622. The ROM 620 can store programs, utilities or processes to be executed in a non-volatile manner. The RAM 622 provides volatile data storage, such as for the cache 606.

The computing device 600 also includes a user input device 608 that allows a user of the computing device 600 to interact with the computing device 600. For example, the user input device 608 can take a variety of forms, such as a button, keypad, dial, touch-sensitive surface, etc. Still further, the computing device 600 includes a display 610 (screen display) that can be controlled by the processor 602 to display information to the user. A data bus 611 can facilitate data transfer between at least the file system 604, the cache 606, the processor 602, an audio coder/decoder (CODEC) 612 and/or a video CODEC 615.

In one embodiment, the computing device 600 serves to store a plurality of digital media assets, namely, media items (e.g., songs, videos, podcasts, etc.) in the file system 604. When a user desires to have the computing device play a particular media item, using the user input device 608, a user can select one of the available media items. The processor 602, upon receiving a selection of a particular media item, supplies the media data to one or more appropriate output devices. If the particular media item is encrypted, the particular media item is first decrypted. As an example, for audio output, the processor 602 can supply the media data (e.g., audio file) for the particular media item to the audio CODEC 612. The audio CODEC 612 can then produce analog output signals for a speaker 614. The speaker 614 can be a speaker internal to the computing device 600 or external to the computing device 600. For example, headphones or earphones that connect to the computing device 600 would be considered an external speaker. As another example, for video output, the processor 602 can supply the media data (e.g., video file) for the particular media item to the video CODEC 615. The video CODEC 615 can then produce output signals for the display 610 and/or the speaker 614.

The computing device 600 also includes a network/bus interface 616 that couples to a data link 618. The data link 618 allows the computing device 600 to couple to another device (e.g., another computing device, server computer, a host computer, or an accessory device). The data link 618 can be provided over a wired connection or a wireless connection. In the case of a wireless connection, the network/bus interface 616 can include a wireless transceiver. The data link 618 can, in some cases, also provide power to the computing device 600 (e.g., to charge the battery 624).

For additional details, including details on submission, distribution and installation of media bundles, see U.S. patent application Ser. No. ______ [Att. Dkt. No. 101-P699], filed concurrently herewith, and entitled “DIGITAL MEDIA BUNDLES FOR MEDIA PRESENTATION PLAYBACK”, which is herein incorporated by reference. For still more additional details, including details on programming interfaces for facilitating use of media bundles to produce media presentations, see U.S. patent application Ser. No. ______ [Att. Dkt. No. 101-P693], filed concurrently herewith, and entitled “PROGRAMMING INTERFACE FOR USE BY MEDIA BUNDLES TO PROVIDE MEDIA PRESENTATIONS”, which is herein incorporated by reference.

The various aspects, features, embodiments or implementations of the invention described above can be used alone or in various combinations.

Embodiments of the invention can, for example, be implemented by software, hardware, or a combination of hardware and software. Embodiments of the invention can also be embodied as computer readable code on a computer readable medium. The computer readable medium is any data storage device that can store data which can thereafter be read by a computer system. Examples of the computer readable medium generally include read-only memory and random-access memory. More specific examples of computer readable medium are tangible and include Flash memory, EEPROM memory, memory card, CD-ROM, DVD, hard drive, magnetic tape, and optical data storage device. The computer readable medium can also be distributed over network-coupled computer systems so that the computer readable code is stored and executed in a distributed fashion.

Numerous specific details are set forth in order to provide a thorough understanding of the present invention. However, it will become obvious to those skilled in the art that the invention may be practiced without these specific details. The description and representation herein are the common meanings used by those experienced or skilled in the art to most effectively convey the substance of their work to others skilled in the art. In other instances, well-known methods, procedures, components, and circuitry have not been described in detail to avoid unnecessarily obscuring aspects of the present invention.

In the foregoing description, reference to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A computer-implemented method for presenting one or more digital media assets at a client machine, the method comprising:
initiating a media presentation program on the client machine, the media presentation program requesting playback of at least one identified digital media asset;
determining whether the identified digital media asset whose playback is requested is available from a local media library associated with the client device;
retrieving the identified digital media asset from the local media library if the identified digital media asset is determined to be available from the local media library associated with the client device;
determining an equivalent digital media asset that is deemed equivalent to the identified digital media asset if the identified digital media asset is determined not to be available from the local media library associated with the client device;
determining whether the equivalent digital media asset is available from the local media library associated with the client device;
retrieving the equivalent digital media asset from the local media library if the equivalent digital media asset is determined to be available from the local media library associated with the client device; and
playing the retrieved identified digital media asset or the retrieved equivalent digital media asset.

2. A computer-implemented method as recited in claim 1, wherein the identified digital media asset is identified by a provider identifier.

3. A computer-implemented method as recited in claim 2, wherein the retrieving of the identified digital media asset is based on the provider identifier.

4. A computer-implemented method as recited in claim 2, wherein the determining identifies the equivalent digital media asset based on the provider identifier.

5. A computer-implemented method as recited in claim 1, wherein the equivalent digital media asset is identified by a distribution identifier.

6. A computer-implemented method as recited in claim 5, wherein the retrieving of the equivalent digital media asset is based on the distribution identifier.

7. A computer-implemented method as recited in claim 1, wherein an identifier conversion table is provided at the client machine,
wherein the identified digital media asset is identified by a provider identifier,
wherein the identifier conversion table maps the provider identifier for at least the identified digital media asset to one or more equivalent digital media assets, and
wherein the determining of the equivalent digital media asset uses the identifier conversion table to map the provider identifier for the identified digital media asset to the one or more equivalent digital media assets.

8. A computer-implemented method as recited in claim 1, wherein an identifier conversion table is provided at the client machine,
wherein the identified digital media asset is identified by a provider identifier,
wherein the identifier conversion table maps the provider identifier for at least the identified digital media asset to a plurality of equivalent digital media assets, with the equivalent digital media assets having an order of priority, and
wherein the determining of the equivalent digital media asset uses the identifier conversion table to map the provider identifier for the identified digital media asset to one of the plurality of the equivalent digital media assets based on the order of priority.

9. A computer-implemented method as recited in claim 1, wherein the client machine is a personal computer or personal portable electronic device.

10. A computer-implemented method for providing conversion data on a client device for facilitating identification of digital media assets to be utilized on the client device, the method comprising:
receiving, at the client device, a media bundle having a plurality of bundle components;
storing the bundle components in local storage in the client device;
receiving, at the client device, the conversion data from a distribution server; and
storing the conversion data in the local storage at the client device.

11. A method as recited in claim 10, wherein the conversion data is received at the client device as one of the bundle components of the media bundle.

12. A method as recited in claim 10, wherein the method further comprises:
requesting conversion data for provider identifiers from a distribution server, and
wherein the conversion data is received at the client device in response to the requesting of the conversion data.

13. A computer-implemented method as recited in claim 10,
wherein the media bundle includes at least the provider identifiers for a plurality of media items, and
wherein the media bundle also includes at least a media presentation program that uses the provider identifiers to identify the media items that are to be played.

14. A computer-implemented method as recited in claim 10, wherein the provider identifiers pertain to media items, and wherein each of the provider identifiers identify a particular media item.

15. A computer-implemented method as recited in claim 10, wherein the provider identifier are assigned by a content provider that has provided digital media assets corresponding to the provider identifiers to a distribution server.

16. A computer-implemented method as recited in claim 10, wherein the conversion data maps each of a plurality of provider identifiers to at least one distributor identifier.

17. A computer-implemented method as recited in claim 10, wherein the conversion data maps the provider identifier for a particular digital media asset to one or more equivalent digital media assets.

18. A computer-implemented method for providing conversion data to a client device for facilitating identification of digital media assets to be utilized on the client device, the method comprising:
electronically sending a media bundle having a plurality of bundle components from a distribution server to the client device, the media bundle includes at least provider identifiers for a plurality of digital media assets and a media presentation program that on operation uses the digital media assets;
determining conversion data pertaining to the provider identifiers; and
electronically sending the conversion data pertaining to the provider identifiers to the client device.

19. A computer-implemented method as recited in claim 18, wherein the conversion data maps each of the plurality of provider identifiers to at least one distributor identifier.

20. A computer-implemented method as recited in claim 18, wherein the conversion data maps each of the provider identifiers for a particular digital media asset to one or more equivalent digital media assets.

21. A computer readable medium including at least computer program code tangibly stored thereon for providing conversion data to a client device for facilitating identification of digital media assets to be utilized on the client device, the computer readable medium comprising:
computer program code for providing a media bundle having a plurality of bundle components at a distribution server; and
computer program code for electronically sending the media bundle from the distribution server to the client device,
the media bundle being sent to the client device includes at least provider identifiers for a plurality of digital media assets, a media presentation program that on operation uses the digital media assets, and conversion data pertaining to the provider identifiers.

22. A computer readable medium as recited in claim 21, wherein the conversion data maps each of the plurality of provider identifiers to at least one distributor identifier, and wherein the conversion data further maps at least one of the provider identifiers for a particular digital media asset to one or more equivalent digital media assets.

23. A computer readable medium including at least computer program code tangibly stored thereon for providing conversion data to a client device for facilitating identification of digital media assets to be utilized on the client device, the computer readable medium comprising:
computer program code for electronically sending a media bundle having a plurality of bundle components from a distribution server to the client device, the media bundle includes at least provider identifiers for a plurality of digital media assets and a media presentation program that on operation uses the digital media assets;
computer program code for determining conversion data pertaining to the provider identifiers; and
computer program code for electronically sending the conversion data pertaining to the provider identifiers to the client device.

24. A computer readable medium as recited in claim 23, wherein the computer readable medium comprises:
computer program code for receiving a request for conversion data pertaining to the provider identifiers.

25. A computer readable medium including at least computer program code tangibly stored thereon for providing conversion data on a client device for facilitating identification of digital media assets to be utilized on the client device, the computer readable medium comprising:
computer program code for receiving a media bundle having a plurality of bundle components;
computer program code for storing the bundle components in local storage in the client device;
computer program code for receiving, at the client device, the conversion data from a distribution server; and
computer program code for storing the conversion data in the local storage at the client device.

26. A computer readable medium including at least computer program code tangibly stored thereon for presenting one or more digital media assets at a client machine, the computer readable medium comprising:
computer program code for initiating a media presentation program on the client machine, the media presentation program requesting playback of at least one identified digital media asset identifier by a provider identifier;
computer program code for converting the provider identifier to a distributor identifier used to identify the identified digital media asset acquired from an online media distribution server and stored in a media library associated with the client device;
computer program code for determining whether the identified digital media asset whose playback is requested is available from the media library associated with the client device based on a distributor identifier;
computer program code for retrieving the identified digital media asset from the media library if the identified digital media asset is determined to be available from the media library associated with the client device;
computer program code for playing the retrieved identified digital media asset.

27. A method as recited in claim 26, wherein said computer readable medium further comprises:
computer program code for determining an equivalent digital media asset that is deemed equivalent to the identified digital media asset if the identified digital media asset is determined not to be available from the media library associated with the client device;
computer program code for determining whether the equivalent digital media asset is available from the media library associated with the client device;
computer program code for retrieving the equivalent digital media asset from the media library if the equivalent digital media asset is determined to be available from the media library associated with the client device; and
computer program code for playing the retrieved equivalent digital media asset.
